(19) United States
(12) Patent Application Publication
(10) Pub. No.: US 2008/0052761 A1
(43) Pub. Date: Feb. 28, 2008

(54) IMAGE FORMING APPARATUS, IMAGE FORMING SYSTEM, COMPUTER READABLE MEDIUM, AND METHOD

(75) Inventor: Hideki MINAMI, Saitama-shi (JP)

Correspondence Address: SUGHRUE MION, PLLC, 2100 PENNSYLVANIA AVENUE, N.W., SUITE 800, WASHINGTON, DC, 20037, US

(73) Assignee: Fuji Xerox Co., Ltd., Tokyo (JP)

(21) Appl. No.: 11/843,221

(22) Filed: Aug. 22, 2007

(30) Foreign Application Priority Data
Aug. 28, 2006 (JP) 2006-231216

(51) Int. Cl. G06F 7/04

(52) U.S. Cl. 726/2

(57) ABSTRACT

An image forming apparatus that includes: a memory that stores image data associated with authentication information; an authentication unit that compares authentication information received through a receiving unit with the authentication information associated with the image data, and performs authentication; an image forming unit that forms an image from the image data stored in the memory, when the authentication is successful; a detector that determines whether an operator is within a detection range; and a controller that controls the image forming unit to stop image formation, when the detector determines that the operator is not within the detection range.

### CROSS-REFERENCE TO RELATED APPLICATIONS

This application is based on and claims priority under 35 USC 119 from Japanese Patent Application No. 2006-231216 filed Aug. 28, 2006.

### BACKGROUND

1. Technical Field

The present invention relates to an image forming apparatus, an image forming system, a computer readable medium storing a program, and a method.

2. Relate Art

In recent years, there have been many systems in which complex machines including printers or printer functions and client apparatuses that output print requests are connected to a network, so that two or more printers can be shared between two or more client apparatuses.

### SUMMARY

According to an aspect of the invention, there is provided an image forming apparatus that includes: a memory that stores image data associated with authentication information; an authentication unit that compares authentication information received through a receiving unit with the authentication information associated with the image data, and performs authentication; an image forming unit that forms an image from the image data stored in the memory, when the authentication is successful; a detector that determines whether an operator is within a detection range; and a controller that controls the image forming unit to stop image formation, when the detector determines that the operator is not within the detection range.

### BRIEF DESCRIPTION OF THE DRAWINGS

Exemplary embodiments of the present invention will be described in detail based on the following figures, wherein:

FIG. 1 is a block diagram showing a system structure in accordance with a first exemplary embodiment of the present invention;

FIG. 2 shows an example of the display screen of the printer driver;

FIG. 3 shows the structure of the operation/display unit of each printing apparatus;

FIG. 4 is a block diagram showing the structure of the controller of each printing apparatus;

FIG. 5 is a flowchart showing the procedures to be carried out in a client terminal to generate print data and transmit the print data to a printing apparatus;

FIG. 6 is a flowchart showing the procedures to be carried out in a printing apparatus that receives print data set for confidential printing in accordance with the first exemplary embodiment;

FIG. 7 is a block diagram showing a system structure in accordance with a second exemplary embodiment of the present invention;

FIG. 8 is a flowchart showing the procedures to be carried out in a printing apparatus that receives print data set for confidential printing in accordance with the second exemplary embodiment;

FIG. 9 is a flowchart showing the procedures to be carried out in a printing apparatus that receives print data set for confidential printing in accordance with a third exemplary embodiment of the present invention;

FIG. 10 is a flowchart showing the procedures to be carried out in a printing apparatus that receives print data set for confidential printing in accordance with a fourth exemplary embodiment of the present invention;

FIG. 11 is a flowchart showing the procedures to be carried out in a printing apparatus that receives print data set for confidential printing in accordance with a fifth exemplary embodiment of the present invention; and

FIG. 12 is a flowchart showing the procedures to be carried out in a printing apparatus that receives print data set for confidential printing in accordance with a sixth exemplary embodiment of the present invention.

### DETAILED DESCRIPTION

The following is a description of exemplary embodiments of the present invention, with reference to the accompanying drawings.

### First Exemplary Embodiment

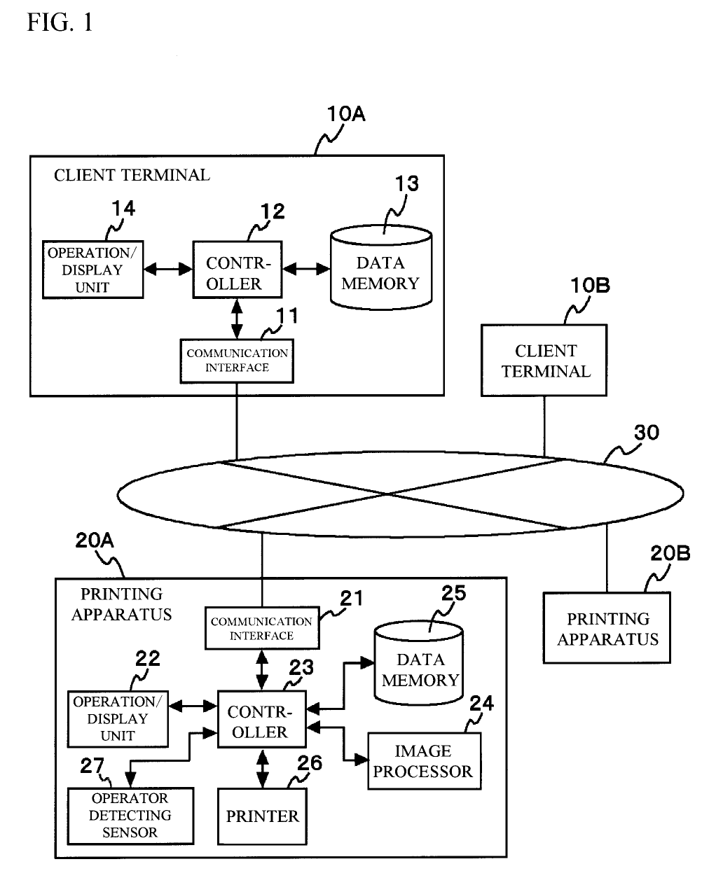

Referring first to FIG. 1, a system structure of this exemplary embodiment is described. In this exemplary embodiment, client terminals 10A and 10B and printing apparatuses 20A and 20B are connected via a network 30, so that bidirectional communication can be performed between the client terminals 10A and 10B and the printing apparatuses 20A and 20B. In the system structure shown in FIG. 1, the two client terminals 10A and 10B and the two printing apparatuses 20A and 20B are connected to the network 30. However, the number of apparatuses is not limited to two, and one apparatus, or three or more apparatuses may be connected to the network. Also, the number of client devices connected to the network 30 may not be equal to the number of printing apparatuses connected to the network 30.

The network 30 may be a LAN (Local Area Network) using lines such as cable lines or not using such lines, a WAN (Wide Area Network), the Intranet, or the Internet. In some cases, the network 30 may be formed with public lines or printer cables.

The structure of the client terminal 10A is now described. Since the client terminal 10B has the same structure as the client terminal 10A, explanation of the client terminal 10B is omitted here. The client terminal 10A may be a personal computer, for example, and includes a communication interface unit 11, a controller 12, a data memory 13, and an operation/display unit 14. The communication interface unit 11 is the interface for bidirectional communication (information exchange) with the printing apparatuses 20A and 20B via the network 30. The control program to be used by the controller 12, information as to the data printing history, and the likes, are stored in the data memory 13. The operation/display unit 14 is the device to be operated by users to input various settings to the client terminal 10A, so as to instruct a printing operation, cancel a printing operation, and check a printing state. The operation/display unit 14 also serves as the display that notifies the operator of the operation result.

The controller 12 reads the control program stored in the data memory 13, and performs an operation in accordance with the control program. By doing so, the controller 12 executes various application programs to produce data such as a document, a figure, and an image, or functions as a printer driver to be used for printing the produced data.

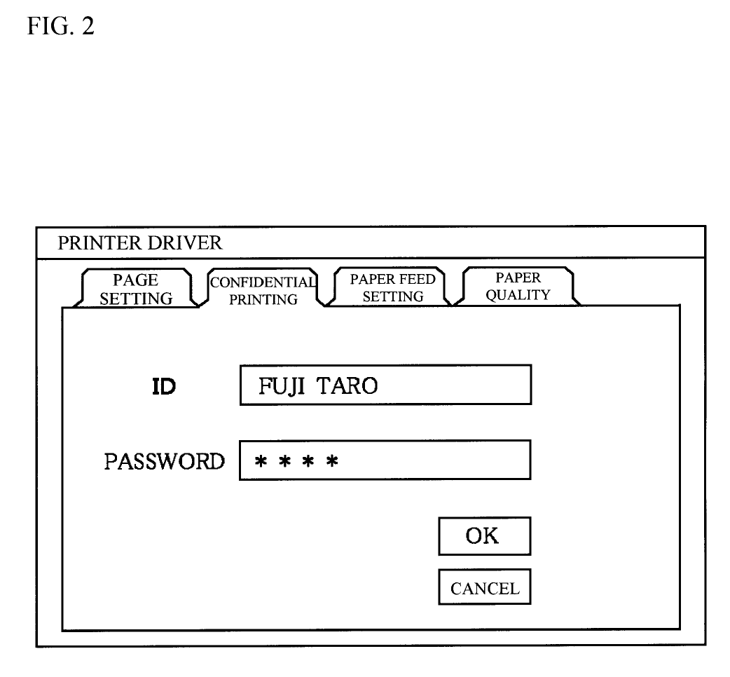

The printer driver processes the data to be printed out, and has a data generating function to generate print data in the PDL (page description language) format and an information adding function to add predetermined information to the print data generated by the data generating function, for example. In a case where a confidential printing operation is performed with the use of the printing system, the additional information to be added by the information adding function includes attribute information indicating that the printing operation is a confidential printing operation, and authentication information (such as user identification information and a password) required for the confidential printing operation. At the time of setting for data printing, the printer driver causes the operation/display unit 14 to display the display screen shown in FIG. 2, and prompts the user to input settings such as the user identification information and a password. The input authentication information is added to the print data in the PDL format as data in the PJL (printer job language) format, for example. The PJL format is also used as the data format when various settings and changes are made by sending command information from the client terminals 10A and 10B to the printing apparatuses 20A and 20B.

Each printing apparatus 20 receives print data transmitted from the client terminal 10A or 10B via the network 30, and prints out the received print data on a recording medium such as a paper sheet. The printing apparatus 20 operates not only in a regular printing mode in which print data received from the client terminals 10A and 10B via the network 30 is not stored and is printed out right away, but also in a confidential printing mode in which print data received from the client terminals 10A and 10B via the network 30 is stored temporarily in the data memory, and previously stored print data is printed out after user authentication using the operation unit of the apparatus.

Confidential printing is a printing operation in which an operator operates the printing apparatus 20A or 20B so that the printout (a paper document) of the print data the operator sent from the client terminal 10A or 10B to the printing apparatus 20A or 20B cannot be seen by others.

Referring back to FIG. 1, the structure of the printing apparatus 20A is described. Since the printing apparatus 20B has the same structure as the printing apparatus 20A, explanation of the printing apparatus 20B is omitted here. As shown in FIG. 1, the printing apparatus 20A includes a communication interface unit 21, an operation/display unit 22, a controller (serving as the authentication unit and the controller of the present invention) 23, an image processor 24, a data memory 25, a printer 26, and an operator detecting sensor 27.

The communication interface unit 21 is the interface for bidirectional communication (information exchange) with the client terminals 10A and 10B via the network 30. The various kinds of information (such as print data) transmitted from the client terminals 10A and 10B are received by the communication interface unit 21 via the network 30, and are then transferred to the controller 23.

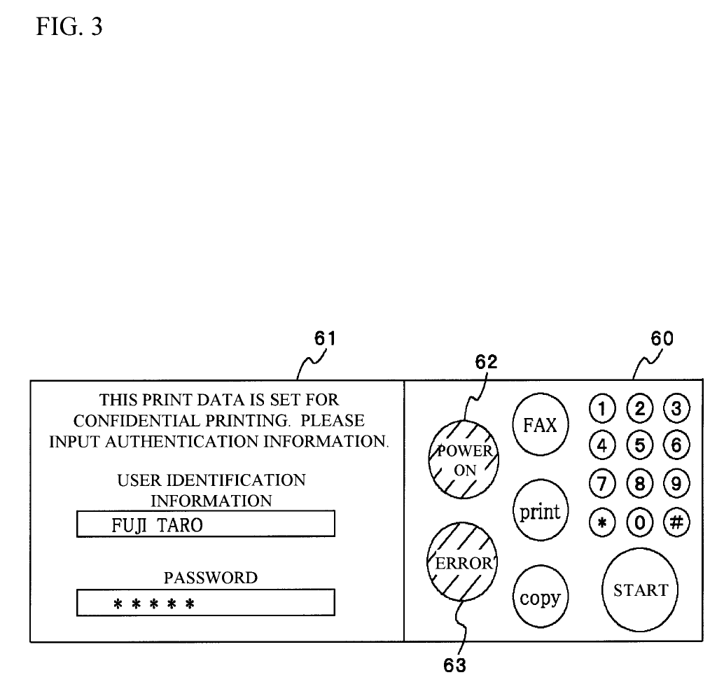

The operation/display unit 22 is the user interface for inputting operations, and includes an operation unit 60 and a display 61. The display may be a liquid crystal display or a CRT, for example. The operation unit 60 may be formed with a general-purpose keyboard or a specially designed operation panel, for example. FIG. 3 shows an example of the operation/display unit 22. A numeric keypad, a start button, FAX-, print-, and copy-start buttons, a power off button, an error display button, and the likes, are provided on the operation unit 60. LEDs (Light Emitting Diodes) are turned on and off, to indicate that each button is selected or not selected.

The controller 23 analyzes information that is received from the client terminal 10A or 10B. Based on the analysis result, the controller 23 transfers the information to some other function unit. If the analyzed information contains print data, the controller 23 transfers the print data to the image processor 24, which then converts the print data into image data that can be printed by the printer 26.

When receiving print data that is transmitted as confidential print data (containing additional information including attribute information that indicates the printing operation to be performed is a confidential printing operation, and authentication information such as user identification information and a password) from the client terminal 10A or 10B, the controller 23 stores the print data and the additional information added to the print data temporarily in the data memory 25. When a print request to print out print data set for confidential printing is input by an operator through the operation/display unit 22, the controller 23 causes the display 61 to display an input request screen for authentication information, and prompts the operator to input the authentication information, as shown in FIG. 3. After the authentication information is input, the controller 23 compares the input authentication information with the authentication information added as the additional information to the print data, to determine whether they match. If the input authentication information matches the authentication information added to the print data, the controller 23 causes the image processor 24 to convert the print data stored in the data memory 25 into image data, and to output the image data to the printer 26. The printer 26 then performs printing.

The input of the authentication information may be performed by a key operation on the operation/display unit 22, or may be performed by reading the authentication information recorded on a portable recording medium (such as an IC card) owned by the operator, when the recording medium is inserted in a slot. Other than that, biological information (such as a finger print) indicating a physical feature of the operator may be used as the authentication information, and the authentication information may be input by detecting the biological information with a sensor (such as a fingerprint sensor).

The controller 23 also receives a detection signal that is output when the operator detecting sensor 27 detects the operator, and then determines whether printing of the print data should be allowed. When the detection signal is not input from the operator detecting sensor 27, the controller 23 determines that there is not the operator near the printing apparatus 20A, and stops the printing of the print data set as a confidential printing operation. When a printing operation is aborted, the controller 23 stores the information as to the page(s) on which the printing of the print data has already been completed in a RAM 43 or a NVRAM (Non-Volatile RAM) 44. In the next printing operation, the information as to the printed page(s) is referred to, so that printing can be resumed from the page next to the last page printing has been completed.

The operator detecting sensor 27 is the sensor for detecting an operation. For example, when detecting the operator near the printing apparatus 20, the operator detecting sensor 27 outputs a detection signal to the controller 23. Although a sensor is employed to detect an operator in this exemplary embodiment, other various methods may be utilized. For example, a camera may be employed to take a picture of the operator, or wireless communication may be performed with an IC tag owned by the operator, so as to detect the operator.

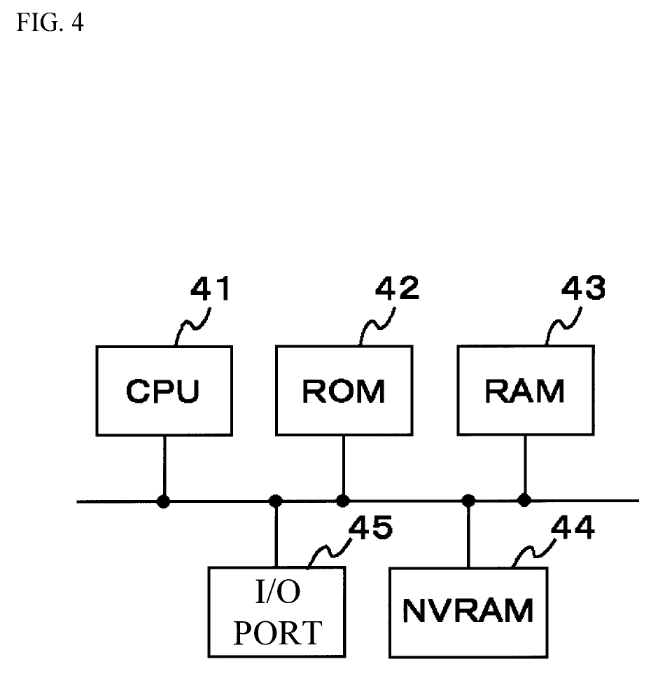

FIG. 4 shows the structure of the controller 23. The controller 23 includes a CPU 41, a ROM 42, the RAM 43, the NVRAM 44, and an I/O port 45. The CPU 41 reads a program stored in the ROM 42, and performs an operation in accordance with the program, to control printing through the procedures shown in a flowchart described later. Operation result data and the printed page information are written in the RAM 43. The data that is written in the RAM 43 and needs to be backed up when the power is turned off is stored in the NVRAM 44.

The program stored in the ROM 42 may be read from a recording medium such as a CD-ROM and then stored in the NVRAM 44, or may be received by the communication interface unit 11 via a network and then stored in the NVRAM 44.

The data memory 25 stores print data for confidential printing and various kinds of information for the confidential printing. The data memory 25 may be a hard disk or a nonvolatile memory (such as an EEPROM).

The printer 26 performs a printing operation based on the print data (image data) transmitted from the controller 23, and prints out an image on a recording medium such as a paper sheet.

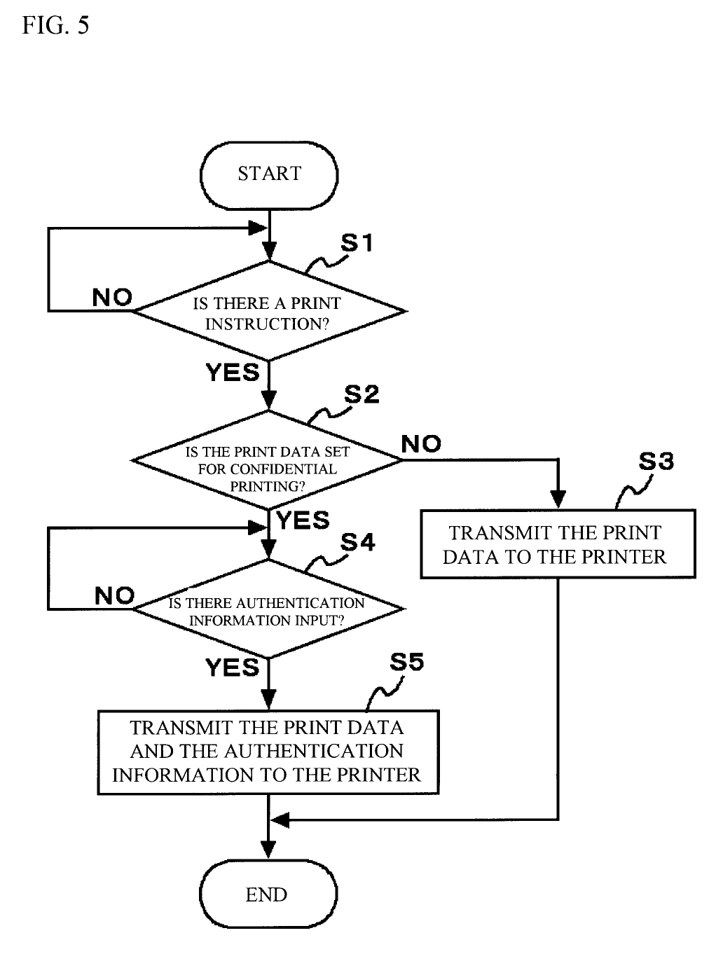

Referring now to the flowchart shown in FIG. 5, the procedures to be carried out to generate print data in the client terminal 10A are described. In the client terminal 10B, print data and a print request are generated in the same manner as described below.

In the client terminal 10A, print data is first created in accordance with an installed application program, and a print instruction is issued (step S1). However, it is not necessary to create print data each time, and it is of course possible to instruct to print out print data already created and stored.

When a print instruction is issued from the application program (“YES” in step S1), the printer driver installed in the client terminal 10A processes the print data to be printed out, and generates print data in the PDL format. In a case where the generated print data is to be printed out in a confidential printing operation (“YES” in step S2), the printer driver causes the operation/display unit 14 to display the screen shown in FIG. 2, and requests an input of authentication information (such as user identification information and a password) required for authentication (step S4).

When authentication data is input (“YES” in step S4), the printer driver adds the attribute information indicating the printing is confidential printing, and the authentication information (such as user identification information and a password) required for the printing information, as the additional information to the print data, and transmits the print data and the additional information to the printing apparatus 20A or 20B (step S5). The additional information is added to the print data in the PDL format as data in the PJL format, for example.

If the printing operation to be performed is not a confidential printing operation (“NO” in step S2), the controller 12 transmits the print data to the printing apparatus 20A or 20B (step S3).

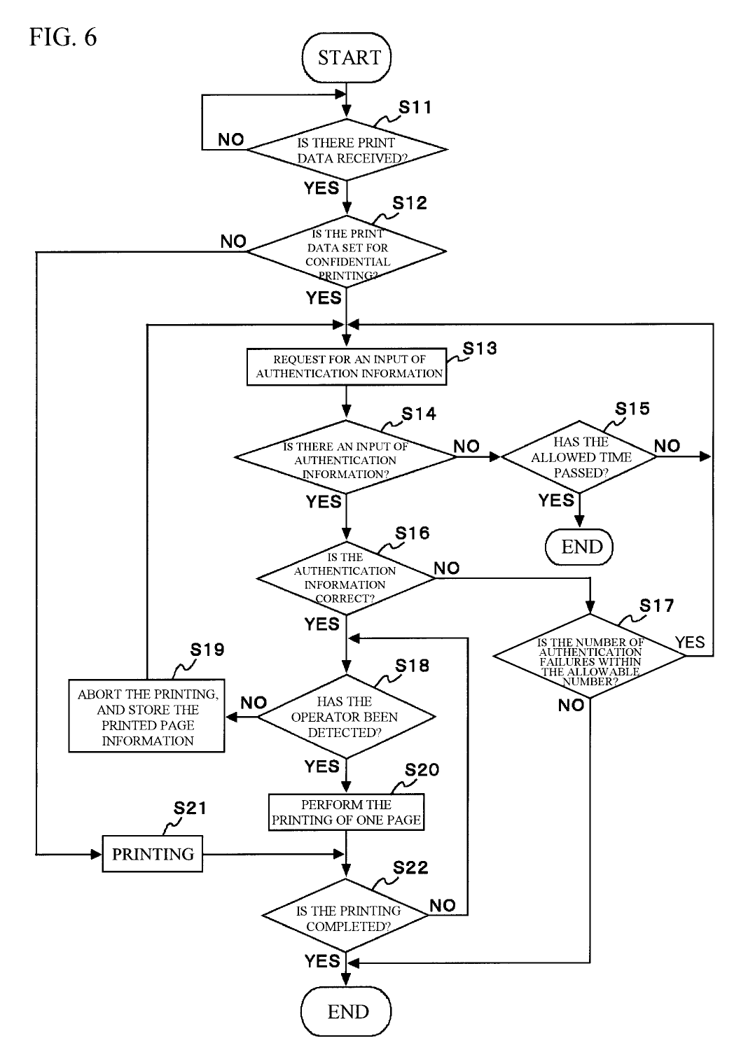

Referring now to the flowchart shown in FIG. 6, an operation to be performed in the printing apparatus 20A that receives print data is described. The same operation as this is also performed in the printing apparatus 20B.

The controller 23 of the printing apparatus 20A stands by for print data from the client terminal 10A (step S11). When receiving print data (“YES” in step S11), the controller 23 analyzes the additional information added to the received print data, and determines whether the print data is set for confidential printing (step S12). If the print data is not set for confidential printing (“NO” in step S12), the controller 23 causes the image processor 24 to convert the received print data into image data, and transfers the image data to the printer 26 to perform a regular printing operation (step S21).

If the print data is set for confidential printing (“YES” in step S12), the controller 23 stores the received print data temporarily in the data memory 25. The controller 23 does not print the print data stored in the data memory 25 as it is, but causes the display 61 to display a request for an input of authentication information on the display screen (step S13) The controller 23 then stands by until an operator inputs authentication information.

In a case where no authentication information is input by an operator over an allowed period of time (“NO” in step S14, and “YES” in step S15), this operation comes to an end. In a case where authentication information is input by an operator within the allowed time (“YES” in step S14), the controller 23 compares the input authentication information with the authentication information added as the additional information (step S16), to determine whether the operator is an authorized user who is allowed to makes copies.

In a case where the input authentication information does not match the authentication information added as the additional information (“NO” in step S16), the controller 23 determines whether the number of authentication failures is within an allowed number (step S17). If the number of authentication failures is within the allowed number (“YES” in step S17), the controller 23 causes the display 61 to display a message to the effect that the authentication has failed, and again requests for an input of authentication information (step S13). If the number of authentication failures exceeds the allowed number (“NO” in step S17), the controller 23 ends this operation.

In a case where the input authentication information matches the authentication information added as the additional information (“YES” in step S16), the controller 23 determines whether the operator detecting sensor 27 has successfully detected the operator (step S18). In a case where the operator detecting sensor 27 fails to detect the operator (“NO” in step S18), the controller 23 ends the operation, and stores the information as to the page(s) on which the printing of the print data has been completed (the printed page information) in a memory such as the RAM 43 (step S19). In a case where the printing has not been completed on even one page, “0” is recorded as the printed page number. In a case where the operator detecting sensor 27 has successfully detected the operator (“YES” in step S18), the controller 23 reads one page of the print data stored in the data memory 25, and causes the image processor 24 to convert the read print data into image data. The controller 23 then outputs the image data to the printer 26 to perform the printing of the one page (step S20). After the printing of the one page is completed, the controller 23 determines whether all the print data has been printed out (step S22). In a case where the printing of all the print data has not been completed (“NO” in step S22), the controller 23 again determines whether the operator detecting sensor 27 has successfully detected the operator (step S18). In a case where the operator detecting sensor 27 has successfully detected the operator (“YES” in step S18), the controller 23 performs the printing of the next one page (step S20). When the operator detecting sensor 27 fails to detect the operator (“NO” in step S18), the controller 23 ends the operation, and stores the printed page information in the data memory 25 (step S19). Those procedures are repeated. When the printing of all the print data has been completed (“YES” in step S22), this operation comes to an end.

### Second Exemplary Embodiment

The following is a description of a second exemplary embodiment of the present invention, with reference to the accompanying drawings. In the above-described first exemplary embodiment, the operator detecting sensor 27 is mounted on each of the printing apparatuses 20A and 20B, so as to determine whether the operator is near the printing apparatus 20A or 20B.

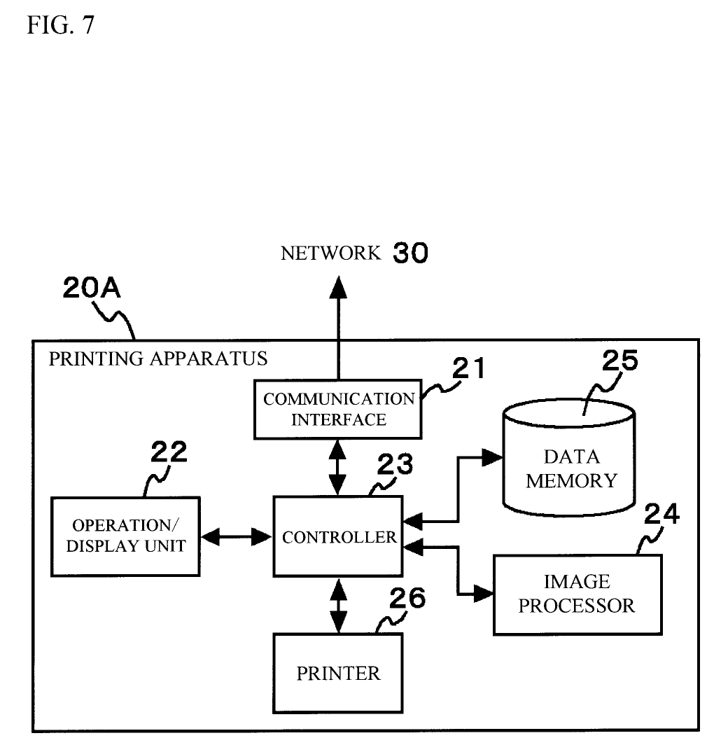

In this exemplary embodiment, a specially designed device is not provided, and an operator near the printing apparatus 20A or 20B is detected by determining whether a certain key of the operation unit 60 is pressed down. In a case where the certain key of the operation unit 60 keeps pressed down, the controller 23 allows the printing of the print data. The certain key may be any key of the operation unit 60. In a case where the display 61 is a touch-panel display having a display screen such as a LCD (Liquid Crystal Display) integrated with a touch panel, the certain key may be displayed on the display 61, and the touch panel detects the key. FIG. 7 shows the structure of the printing apparatus 20A of this exemplary embodiment.

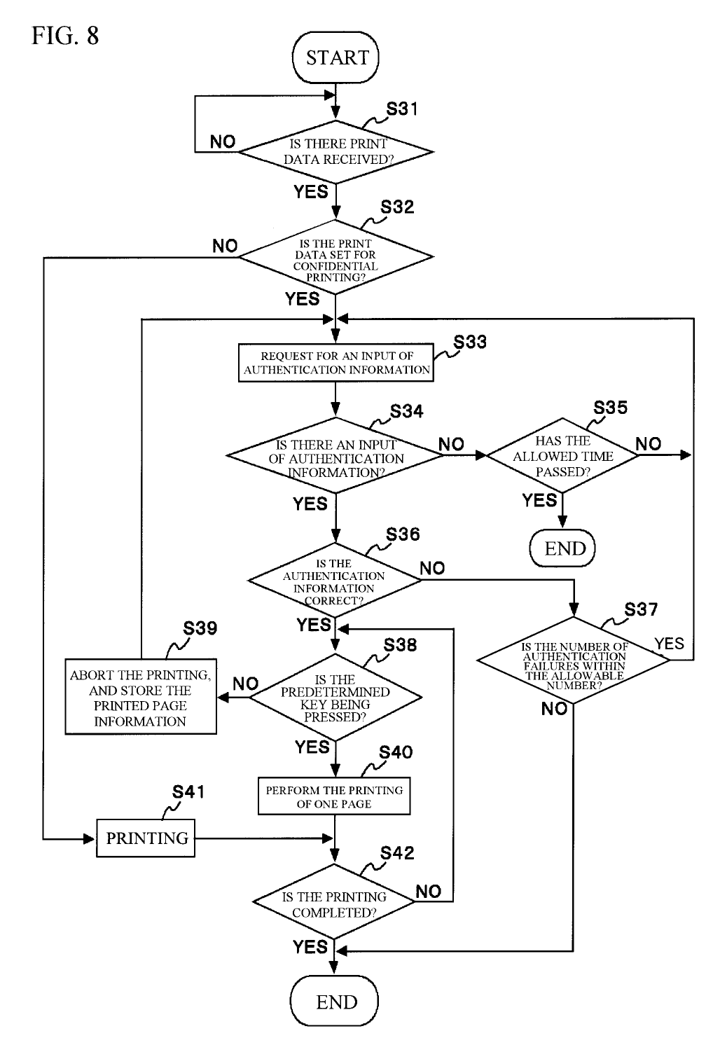

Referring now to the flowchart shown in FIG. 8, an operation in accordance with this exemplary embodiment is described. Since the procedures from an input of authentication information till authentication are the same as those of the first exemplary embodiment, explanation of them is omitted here.

The controller 23 compares the authentication information input through the operation unit 60 with the authentication information extracted from the additional information, to determine whether they match (step S36). If the input authentication information matches the extracted authentication information (“YES” in step S36), the controller 23 determines whether the certain key of the operation unit 60 is pressed down (step S38). If the certain key is pressed down (“YES” in step S38), the controller 23 reads one page of the print data stored in the data memory 25, and causes the image processor 24 to convert the read print data into image data. The controller 23 then outputs the image data to the printer 26 to perform printing (step S40). After the printing of the one page is finished, the controller 23 determines whether all the print data has been printed out (step S42). In a case where the printing of all the print data has not been completed (“NO” in step S42), the controller 23 determines whether the certain key has kept pressed down (step S38). In a case where the certain key has kept pressed down (“YES” in step S38), the controller 23 performs the printing of the next one page (step S40). In this manner, while the certain key of the operation unit 60 keeps pressed down, the print data is read from the data memory 25, and printing is performed. When the certain key of the operation unit 60 stops being pressed down (“NO” in step S38), the controller 23 ends the operation, and stores the printed page information in the data memory 25 (step S39)

### Third Exemplary Embodiment

The following is a description of a third exemplary embodiment of the present invention, with reference to the accompanying drawings. Since the structure of this exemplary embodiment is the same as the structure of the above-described second exemplary embodiment, explanation of it is omitted here.

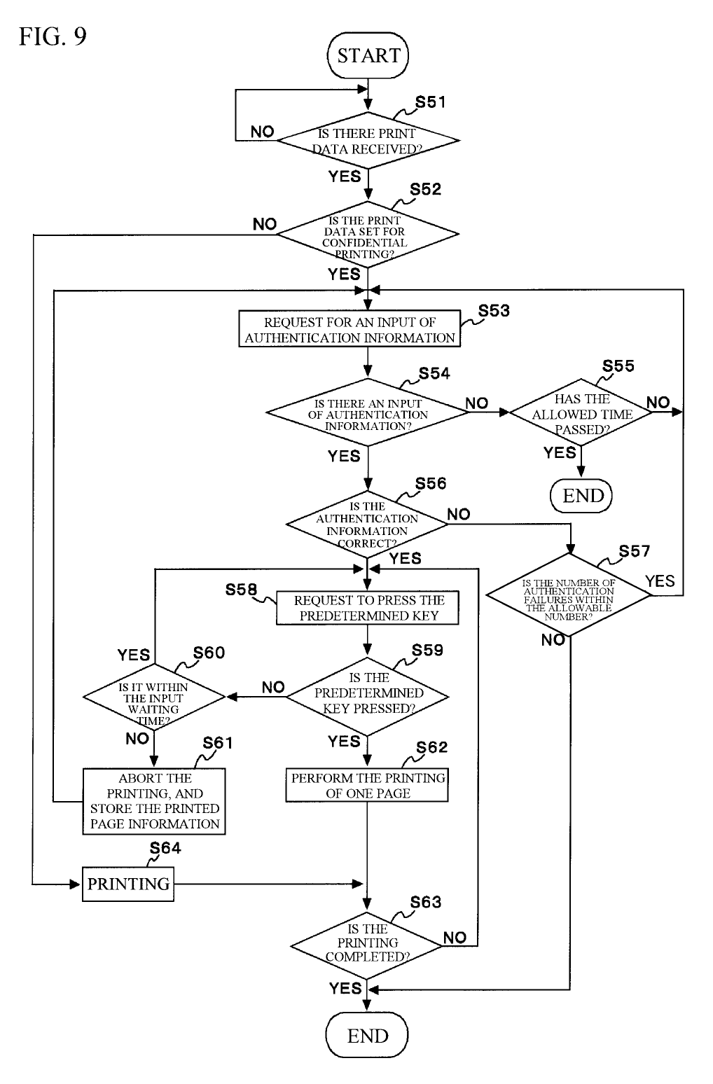

In the second exemplary embodiment, printing of print data is performed while a certain key keeps pressed down. In this exemplary embodiment, an operator is requested to make a key input for each one page. Referring now to the flowchart shown in FIG. 9, an operation in accordance with this exemplary embodiment is described. Since the procedures from an input of authentication information till authentication in this exemplary embodiment are the same as those of the first exemplary embodiment, explanation of them is omitted here.

The controller 23 compares the authentication information input through the operation unit 60 with the authentication information extracted from the additional information, to determine whether they match (step S56). If the input authentication information matches the extracted authentication information (“YES” in step S56), the controller 23 causes the display 61 to display a screen for requesting the operator to press the certain key of the operation unit 60 (step S58). In a case where the certain key has not been pressed during a predetermined input waiting time since the request to press the certain key (“NO” in step S59, and “NO” in step S60), the controller 23 ends the operation, and stores “0” as the printed page number in a memory such as the RAM 43. If the certain key is pressed within the input waiting time (“YES” in step S59), the controller 23 reads one page of the print data stored in the data memory 25, and causes the image processor 24 to convert the read print data into image data. The controller 23 then outputs the image data to the printer 26 to perform printing (step S62). After the printing of the one page is finished, the controller 23 determines whether all the print data has been printed out (step S63). In a case where the printing of all the print data has not been completed (“NO” in step S63), the controller 23 again causes the display 61 to display the request to press the certain key (step S58). If the certain key is pressed (“YES” in step S59), the controller 23 performs the printing of the next one page (step S62). In a case where the certain key is not pressed during the input waiting time (“NO” in step S59, and “NO” in step S60), the controller 23 ends the operation, and stores the printed page information in the data memory 25 (step S61).

### Fourth Exemplary Embodiment

The following is a description of a fourth exemplary embodiment of the present invention, with reference to the accompanying drawings. Since the structure of this exemplary embodiment is also the same as the structure of the above-described second exemplary embodiment, explanation of it is omitted here. In the third exemplary embodiment, the operator is requested to press the certain key for the printing of each one page. In this exemplary embodiment, when the certain key is pressed, printing of print data within a predetermined print allowed time is allowed. Accordingly, printing of more than one page is allowed.

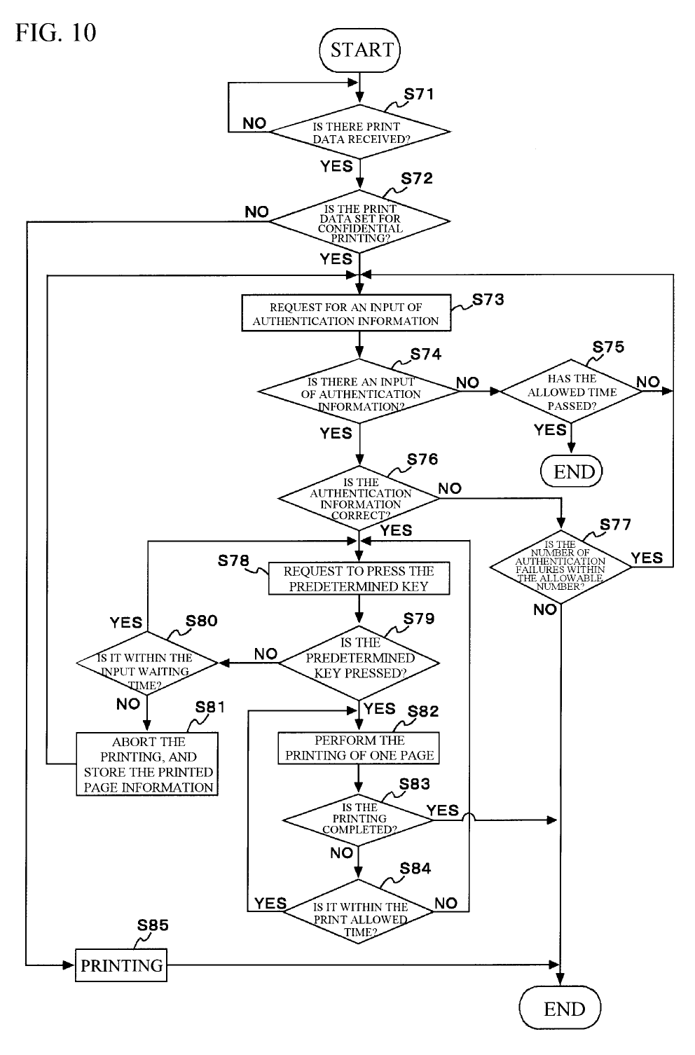

Referring now to the flowchart shown in FIG. 10, an operation in accordance with this exemplary embodiment is described. Since the procedures from an input of authentication information till authentication in this exemplary embodiment are also the same as those of the first exemplary embodiment, explanation of them is omitted here.

The controller 23 compares the authentication information input through the operation unit 60 with the authentication information extracted from the additional information, to determine whether they match (step S76). If the input authentication information matches the extracted authentication information (“YES” in step S76), the controller 23 causes the display 61 to display a screen for requesting the operator to press the certain key of the operation unit 60 (step S78). In a case where the certain key has not been pressed during a predetermined input waiting time since the request to press the certain key (“NO” in step S79, and “NO” in step S80), the controller 23 ends the operation, and stores “0” as the printed page information in a memory such as the RAM 43.

If the certain key is pressed within the input waiting time (“YES” in step S79), the controller 23 reads one page of the print data stored in the data memory 25, and causes the image processor 24 to convert the read print data into image data. The controller 23 then outputs the image data to the printer 26 to perform printing (step S82). After the printing of the one page is finished, the controller 23 determines whether all the print data has been printed out (step S83). In a case where the printing of all the print data has not been completed (“NO” in step S83), the controller 23 determines whether the time elapsed since the pressing of the certain key is within the print allowed time (step S84). If the elapsed time is within the print allowed time (“YES” in step S84), the controller 23 reads the next one page of the print data stored in the data memory 25, and performs the printing of the next one page (step S82). In a case where the elapsed time is longer than the print allowed time (“NO” in step S84), the controller 23 causes the display 61 to display the screen for requesting the operator to press the certain key of the operation unit 60 (step S78), and stands by until the certain key is pressed (step S79). If the certain key is pressed within the predetermined input waiting time (“YES” in step S79), the controller 23 allows printing within the print allowed time.

### Fifth Exemplary Embodiment

The following is a description of a fifth exemplary embodiment of the present invention, with reference to the accompanying drawings. Since the structure of this exemplary embodiment is also the same as the structure of the above-described second exemplary embodiment, explanation of it is omitted here.

In the above-described fourth exemplary embodiment, when the certain key is pressed, printing of print data is allowed within the predetermined print allowed time.

In this exemplary embodiment, an LED or the like is used to indicate the remaining time of the print allowed time. The controller 23 changes the blinking rate of the LED, depending on the remaining time. The LED used for the display may be a LED 62 shown in FIG. 3 for indicating that the power is on, or a LED 63 shown in FIG. 3 for indicating that there is an error, or some other LED.

The method of displaying the print allowed time involves not only adjusting the blinking rate of the LED, but also displaying the remaining time of the print allowed time on the display 61.

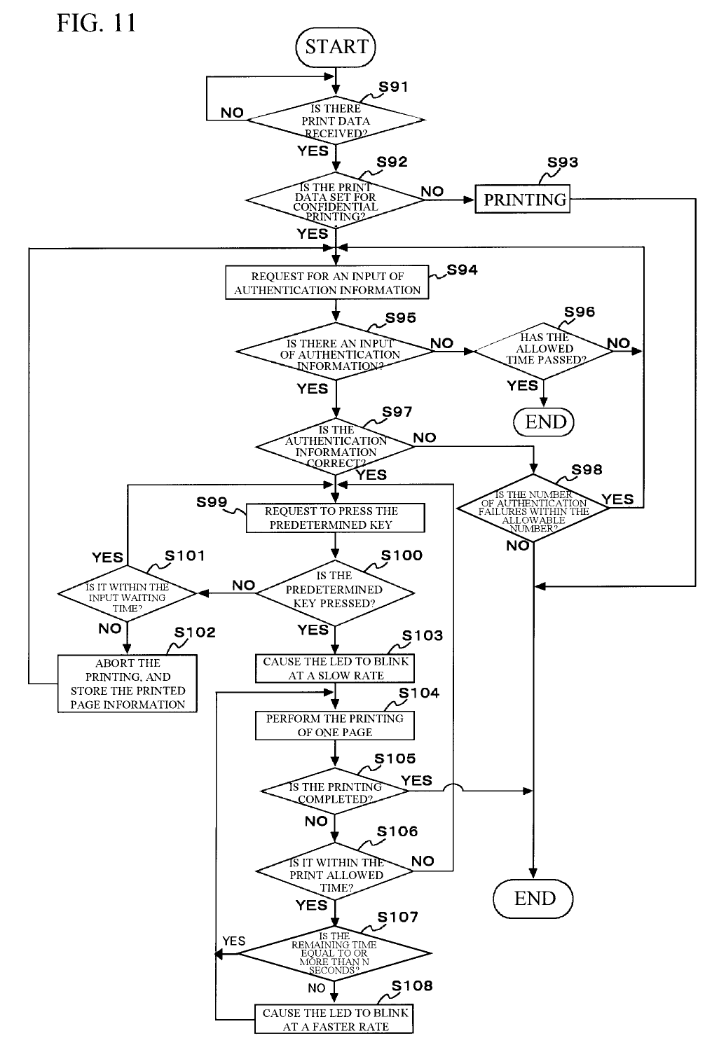

Referring now to the flowchart shown in FIG. 11, an operation in accordance with this exemplary embodiment is described. Since the procedures from an input of authentication information till authentication in this exemplary embodiment are also the same as those of the first exemplary embodiment, explanation of them is omitted here.

The controller 23 compares the authentication information input through the operation unit 60 with the authentication information extracted from the additional information, to determine whether they match (step S97). If the input authentication information matches the extracted authentication information (“YES” in step S97), the controller 23 causes the display 61 to display a screen for requesting the operator to press the certain key of the operation unit 60 (step S99). In a case where the certain key has not been pressed during a predetermined input waiting time since the request to press the certain key (“NO” in step S100, and “NO” in step S101), the controller 23 ends the operation, and stores “0” as the printed page information in a memory such as the RAM 43. If the certain key is pressed within the input waiting time (“YES” in step S100), the controller 23 causes the LED to blink at a slow rate (step S103). The controller 23 reads one page of the print data stored in the data memory 25, and causes the image processor 24 to convert the read print data into image data. The controller 23 then outputs the image data to the printer 26 to perform printing (step S104). After the printing of the one page is finished, the controller 23 determines whether all the print data has been printed out (step S105). In a case where the printing of all the print data has not been completed (“NO” in step S105), the controller 23 determines whether the time elapsed since the pressing of the certain key is within the print allowed time (step S106). If the elapsed time is within the print allowed time (“YES” in step S106), the controller 23 determines whether the remaining time till the end of the print allowed time is equal to or more than N (N being an integer) seconds (step S107). If the remaining time is equal to or more than N seconds (“YES” in step S107), the controller 23 reads the next one page of the print data from the data memory 25, and performs the printing of the next one page (step S104). If the remaining times is less than N seconds (“NO” in step S107), the controller 23 makes the blinking rate of the LED faster (step S108), and notifies the operator that the print allowed time will soon come to an end. The controller 23 then reads the next page of the print data from the data memory 25, and performs the printing of the next page (step S104).

### Sixth Exemplary Embodiment

The following is a description of a sixth exemplary embodiment of the present invention, with reference to the accompanying drawings. Since the structure of this exemplary embodiment is also the same as the structure of the above-described second exemplary embodiment, explanation of it is omitted here.

In the above-described fourth and fifth exemplary embodiments, a print allowed time during which printing is allowed is set, and printing of two or more pages is allowed in the print allowed time. In this exemplary embodiment, when a certain key is pressed, printing of a predetermined number of pages is allowed.

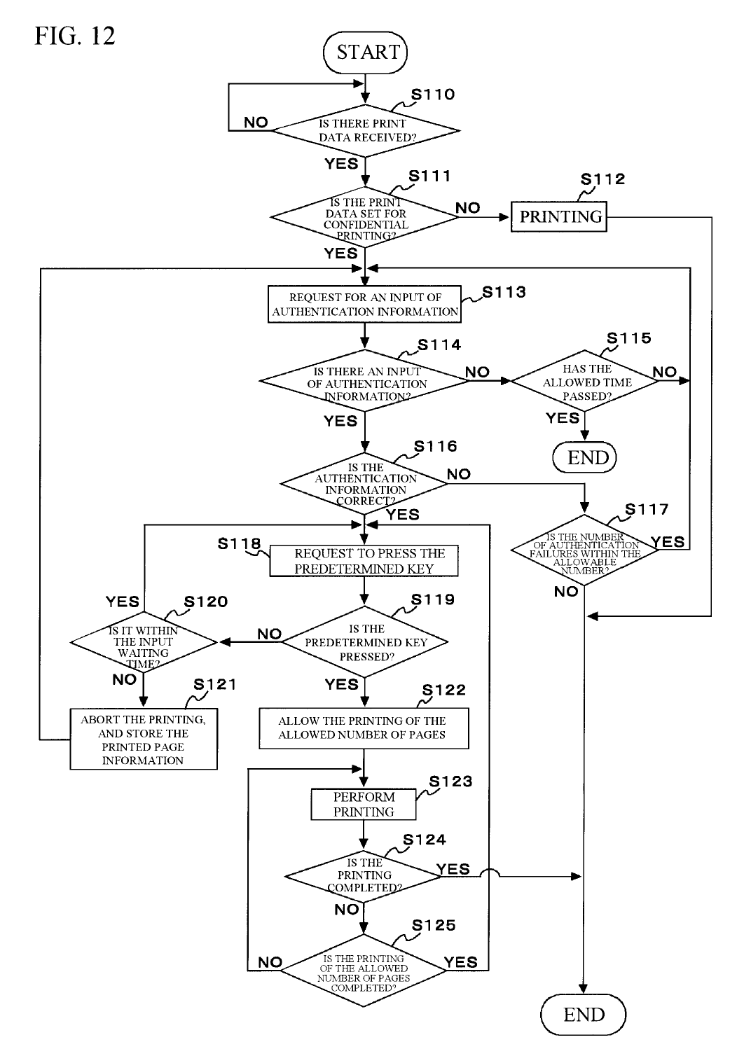

Referring now to the flowchart shown in FIG. 12, an operation in accordance with this exemplary embodiment is described. Since the procedures from an input of authentication information till authentication in this exemplary embodiment are also the same as those of the first exemplary embodiment, explanation of them is omitted here.

The controller 23 compares the authentication information input through the operation unit 60 with the authentication information extracted from the additional information, to determine whether they match (step S116). If the input authentication information matches the extracted authentication information (“YES” in step S116), the controller 23 causes the display 61 to display a screen for requesting the operator to press the certain key of the operation unit 60 (step S118). In a case where the certain key has not been pressed during a predetermined input waiting time since the request to press the certain key (“NO” in step S119, and “NO” in step S120), the controller 23 ends the operation, and stores “0” as the printed page information in a memory such as the RAM 43 (step S121). If the certain key is pressed within the input waiting time (“YES” in step S119), the controller 23 reads one page of the print data stored in the data memory 25, and causes the image processor 24 to convert the read print data into image data. The controller 23 then outputs the image data to the printer 26 to perform printing (step S122). After the printing of the one page is finished, the controller 23 determines whether all the print data has been printed out (step S124). In a case where the printing of all the print data has not been completed (“NO” in step S124), the controller 23 determines whether the number of printed pages is the same as the number of pages allowed to be printed (step S125). If the number of printed pages is the same as the number of pages allowed to be printed (“YES” in step S125), the controller 23 causes the display 61 to display the screen for requesting the operator to press the certain key of the operation unit 60 (step S118), and stands by until the certain key is pressed (step S119). If the certain key is pressed within the predetermined input waiting time (“YES” in step S119), the controller 23 allows printing of the next print allowed pages, which start from the next page to the last page printing has been completed (step S122).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various exemplary embodiments and with various modifications as are suited to the particular use contemplated. It is intended that the scope of the invention be defined by the following claims and their equivalents.

What is claimed is:

1. An image forming apparatus comprising:
a memory that stores image data associated with authentication information;
an authentication unit that compares authentication information received through a receiving unit with the authentication information associated with the image data, and performs authentication;
an image forming unit that forms an image from the image data stored in the memory, when the authentication is successful;
a detector that determines whether an operator is within a detection range; and
a controller that controls the image forming unit to stop image formation, when the detector determines that the operator is not within the detection range.

2. The image forming apparatus according to claim 1, wherein the controller allows image formation, when the operator is determined to be within the detection range.

3. The image forming apparatus according to claim 1, wherein the controller stores, in the memory, information as to the last page on which image formation is completed, when image formation is stopped.

4. The image forming apparatus according to claim 3, wherein the controller again requests an input of the authentication information through the receiving unit, after stopping the image formation.

5. The image forming apparatus according to claim 1, wherein the detector detects the operator when an operation is received.

6. The image forming apparatus according to claim 5, wherein the controller allows image formation while the receiving unit receives an operation.

7. The image forming apparatus according to claim 5, wherein the controller does not allow image formation unless the receiving unit receives an operation.

8. The image forming apparatus according to claim 5, wherein the controller allows image formation of an allowed number of pages, when the receiving unit receives an operation.

9. The image forming apparatus according to claim 8, wherein the controller allows image formation of the allowed number of pages, when the receiving unit receives an operation within an allowed time.

10. The image forming apparatus according to claim 8, wherein the controller does not allow image formation unless the receiving unit receives an operation within an allowed time.

11. The image forming apparatus according to claim 5, wherein the controller allows image formation during an allowed time, when the receiving unit receives an operation.

12. The image forming apparatus according to claim 11, further comprising a display that displays a message to the effect that an ending time comes soon, when an end of the allowed time nears.

13. An image forming system comprising:
a computer that generates image data associated with authentication information, and transmits the image data and the authentication information to an image forming apparatus; and
the image forming apparatus that includes: a receiving unit that receives the image data associated with the authentication information; a memory that stores the image data associated with the authentication information; an authentication unit that compares authentication information received through the receiving unit with the authentication information associated with the image data, and performs authentication; an image forming unit that forms an image from the image data stored in the memory, when the authentication is successful; a detector that determines whether an operator is within a detection range; and a controller that controls the image forming unit to stop image formation, when the detector determines that the operator is not within the detection range.

14. The image forming system according to claim 13, wherein the controller allows image formation when the operator is determined to be within the detection range.

15. A computer readable medium storing a program causing a computer to execute a process for controlling an image forming apparatus, the process comprising:
comparing authentication information received through a receiving unit with authentication information associated with image data;
forming an image from the image data when the authentication is successful;
determining whether an operator is within a detection range; and
stopping image formation when the operator is determined not to be within the detection range.

16. The computer readable medium according to claim 15, wherein the process further comprises allowing image formation when the operator is determined to be within the detection range.

17. An image forming method comprising:
comparing authentication information received through a receiving unit with authentication information associated with image data;
forming an image from the image data when the authentication is successful;
determining whether an operator is within a detection range; and
stopping image formation when the operator is determined not to be within the detection range.

18. The image forming method according to claim 17, wherein the process further comprises allowing image formation when the operator is determined to be within the detection range.
